(19) United States
(12) Patent Application Publication
(10) Pub. No.: US 2004/0052631 A1
(43) Pub. Date: Mar. 18, 2004

(54) Mechanical arm device for carrying and detecting wafer

(76) Inventors: Kun Yuan Chan, Taichung (TW); Jen Chin Ho, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/242,738

(22) Filed: Sep. 13, 2002

(51) Int. Cl. B66C 23/00

(52) U.S. Cl. 414/744.2

(57) ABSTRACT

A mechanical arm device for carrying and detecting a wafer comprises a seat and an arm mechanism coupled to seat and including an elbow, a forearm, and a sensor wherein elbow is controlled by seat, forearm is secured to one end of elbow and includes a front fork, and sensor is secured to a bottom of forearm at its free end, extended from fork, and electrically coupled to seat through a signal cord. In operation, the arm device carries wafer for feeding into a wafer container for measuring wafer by sensor in a non-contact manner. It ensures a highly correct horizontal level and height measuring of wafer.

### FIELD OF THE INVENTION

The present invention relates to mechanical arm device and more particularly to such a mechanical arm device carrying wafer for feeding into a wafer container for measuring a horizontal level and a height of wafer in a detection operation. After the detection operation, wafer is fetched out of the wafer container by the mechanical arm device.

### BACKGROUND OF THE INVENTION

Electronic technologies have known a rapid and a spectacular development recently. Further, there is a trend of developing slim, compact electronic products for tailoring the needs of consumers. As such, manufacturing processes of integrated circuits (ICs) are critical to the quality of ICs. Conventionally, there are almost 100 processes such as diffusion, printing, etching, masking, and reading marker in manufacturing ICs from wafers. Typically, wafer container such as cassette, boat, POD, or FOUP capable of storing a plurality of wafers is used to transport wafers among wafer cassette stations (or sorters) of various interbays during the processes.

Conventionally, a rack is provided on walls in wafer container. A wafer is placed on one of a plurality of levels of rack. Horizontal level and height of plurality of wafers placed on the levels of rack must be highly correct for preventing a mechanical arm device from contacting, thus damaging wafer when an arm mechanism is extending into wafer container. Hence, operator must measure horizontal level of rack before using the wafer container in order to ensure that stored wafers have correct horizontal level.

Laser is typically used in measuring horizontal level and height of wafers in wafer container. In operation, laser head is extended into wafer container for measuring a horizontal level of several internal pivots which are responsible for supporting wafers. However, the prior art aims at a measuring of wafer container rather than wafers stored in wafer container. This means that a correct measuring of horizontal level of wafer container does not represent a correct measuring of horizontal level of wafer in wafer container. Thus improvement exists.

### SUMMARY OF THE INVENTION

It is therefore an object of the present invention to provide a mechanical arm device for carrying and detecting wafer. In operation, the mechanical arm device carries wafer for feeding into a wafer container for measuring wafer by a sensor in a non-contact manner. The invention ensures a highly correct horizontal level and height measuring of wafer.

It is another object of the present invention to provide a mechanical arm device for carrying and detecting wafer. The invention aims at a measuring of horizontal level and height of wafer stored in wafer container. Hence, the measuring result is more correct and substantially represents the actual state of wafer stored in wafer container.

The above and other objects, features and advantages of the present invention will become apparent from the following detailed description taken with the accompanying drawings.

### BRIEF DESCRIPTION OF THE DRAWINGS

FIG. 1 is an exploded perspective view of a mechanical arm device according to the invention;

FIG. 2 is a perspective view of a portion of the assembled mechanical arm device;

FIG. 3 is a schematic perspective view showing an operation of feeding a wafer into wafer container; and

FIG. 4 is view similar to FIG. 3 wherein a detection operation of wafer is made possible after wafer has been placed in wafer container.

FIG. 5 is the illustrative view of a plurality of forearm applied by this invention; and

FIG. 6 is the illustrative view of operation in application with another detection according to the present invention.

### DETAILED DESCRIPTION OF THE PREFERRED EMBODIMENTS

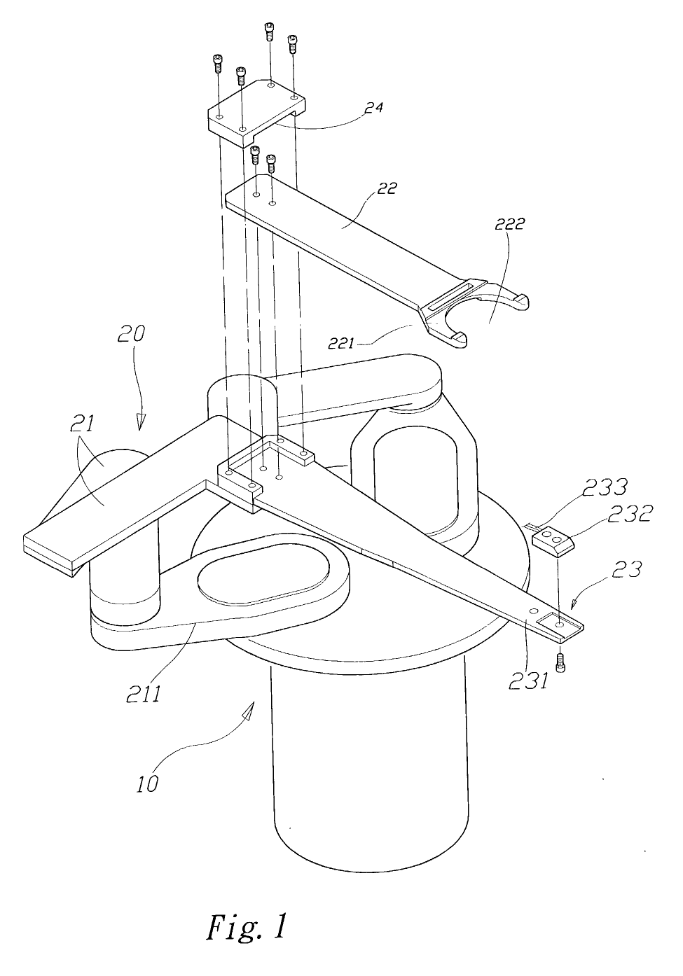

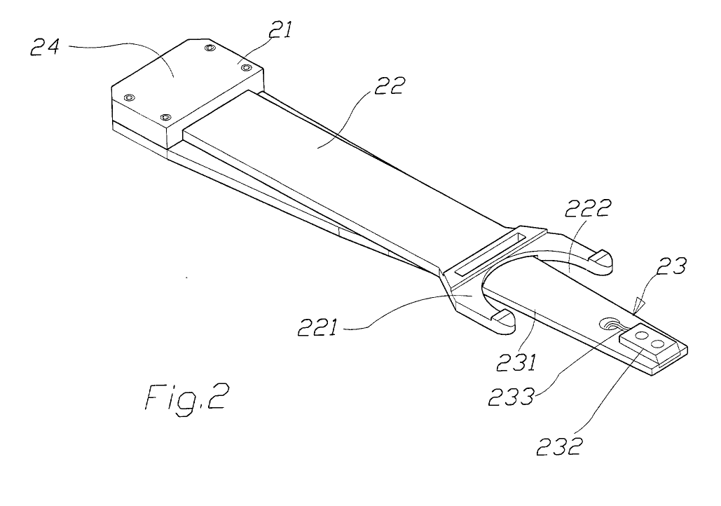

Referring to FIGS. 1 and 2, there is shown a mechanical arm device constructed in accordance with the invention comprising a seat 10 and an arm mechanism 20 coupled to the seat 10 and including an elbow 21, a forearm 22, and a sensor 23. Elbow 21 comprises several short elements 211 pivotably connected together. The operation of elbow 21 is controlled by signals transmitted from seat 10. Forearm 22 is threadedly secured to one end of elbow 21. Forearm 22 comprises a front fork 221 and a recess 222 in the front fork 221. Sensor 23 is threadedly secured to a bottom of forearm 22 at a free end. Sensor 23 comprises a lever 231 extended from the recess 221 and a digital displacement sensor 232 (or laser sensor in the other embodiment) threadedly secured to a front bottom end of lever 231. The digital displacement sensor 232 is electrically coupled to seat 10 through a cord 233 for signal transmission.

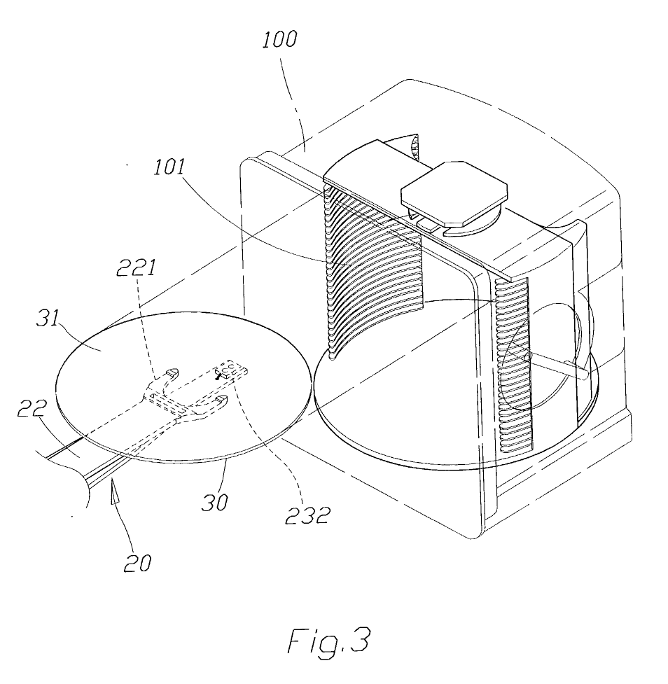

Referring to FIG. 3, the mechanical arm device of the invention is operative to carry a wafer 30 to feed into a wafer container 100. Wafer 30 to be detected has a layer of metal film 31 plated or coated thereon. In the other embodiment, a layer of metal film 31 is adhered on the wafer 30 to be detected at a detection station. Such layer of metal film 31 is responsive to digital displacement sensor 232 in the detection operation. Eventually, wafer 30 is placed on a level of rack 101 in both walls of wafer container 100.

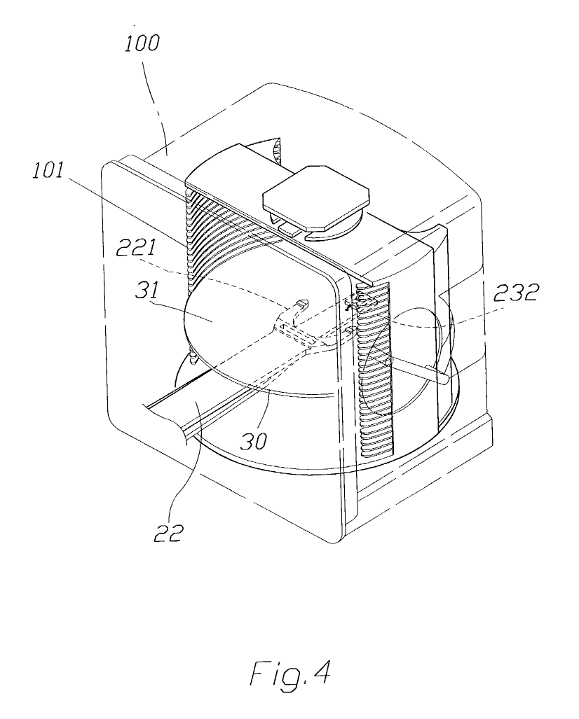

Referring to FIG. 4, the detection operation (i.e., horizontal level and height measuring) of wafer 30 will now be described in detail. First, seat 10 is reset with respect to digital displacement sensor 232. Then forearm 22 of arm mechanism 20 is operative to carry wafer 30. A detection on wafer 30 is performed by arm mechanism 20 after wafer 30 has been placed on a level of rack 101 in wafer container 100. It is possible of measuring several points of wafer 30 by the digital displacement sensor 232 in a non-contact manner since the digital displacement sensor 232 is located below the front fork 221. This also ensures that digital displacement sensor 232 will not be damaged by scraping in carrying wafer 30 for detection. The advantage is that the mechanical arm device of the invention aims at a measuring of horizontal level and height of wafer stored in wafer container rather than that of wafer container. In comparison with prior art, the measuring result of the invention is more correct and substantially represents the actual state of wafer stored in wafer container.

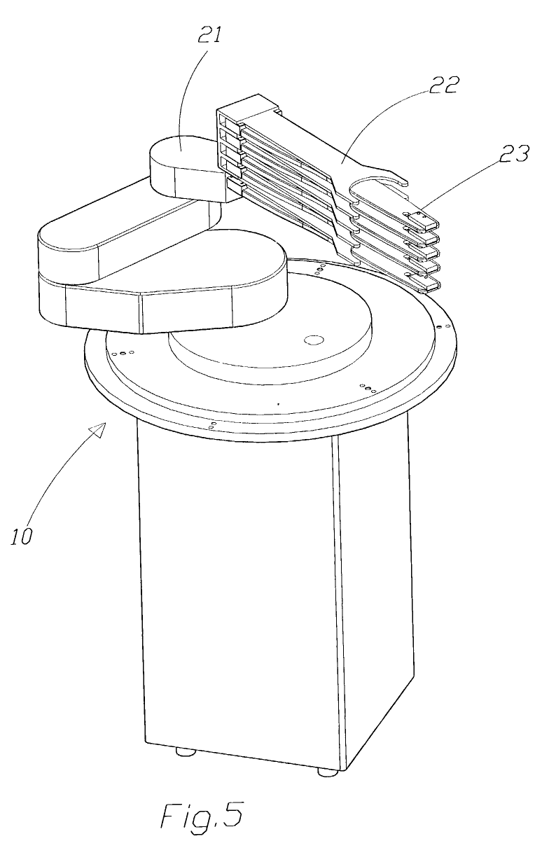

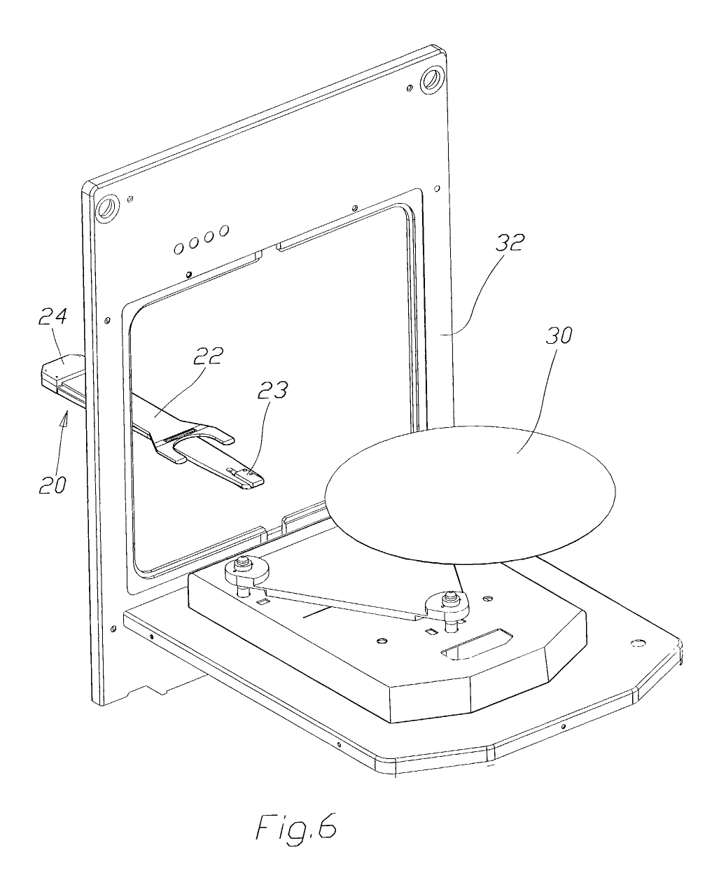

Referring to FIG. 5, which is the illustrative view of a plurality of forearm applied by this invention, wherein the end of said elbow 21 is connecting a plurality of forearm 22 and the sensor 23 which could precede the operation of measure toward a plurality of water trays to elevate the integrated operation performance. Besides, as shown in FIG. 6, which is the apparatus that said sensor 23 is matching with the metallic-made wafer 30 (or there electroplates a layer of metal on the surface of wafer) and to adjust the level of the arm mechanism 20 and the gate seat 32 of the platform of the wafer loading/dislodging.

While the invention has been described by means of specific embodiments, numerous modifications and variations could be made thereto by those skilled in the art without departing from the scope and spirit of the invention set forth in the claims.

What is claimed is:

1. A mechanical arm device for carrying and detecting a wafer comprising a seat and an arm mechanism coupled to the seat and including an elbow, a forearm, and a sensor wherein the elbow is controlled by the seat, the forearm is secured to one end of the elbow and includes a front fork, and the sensor is secured to a bottom of the forearm at its free end, extended from the front fork, and electrically coupled to the seat through a signal cord.

2. The mechanical arm device of claim 1, wherein the elbow comprises a plurality of short elements pivotably connected together.

3. The mechanical arm device of claim 1, wherein the forearm further comprises a recess in the front fork.

4. The mechanical arm device of claim 1, wherein the sensor comprises a lever secured to a bottom end of the elbow and a sensor threadedly secured to a front bottom end of the lever.

5. The mechanical arm device of claim 1, wherein said elbow could connect with a plurality of forearm and the sensor which could measure the position and the degree of levelness of a plurality of wafer.

6. The mechanical arm device of claim 1, wherein said sensor and said horizontal supporting platform could also be the apparatus of adjusting the level of the forearm and the gate seat of the platform of the wafer loading/dislodging in matching with the metallic-made wafer.
